(19) United States
(12) Patent Application Publication
(10) Pub. No.: US 2026/0308393 A1
(43) Pub. Date: Oct. 8, 2026

(54) FLAME RETARDANT POLYMERIC COMPOSITIONS

(71) Applicant: Dow Global Technologies LLC, Midland, MI (US)

(72) Inventors: Bharat I. Chaudhary, Princeton, NJ (US); Chongsoo Lim, Hockessin, DE (US); Jeffrey M. Cogen, Flemington, NJ (US); Richard I. Tapper, Philadelphia, PA (US)

(21) Appl. No.: 19/481,237

(22) PCT Filed: Jun. 26, 2024
(86) PCT No.: PCT/US2024/035502

§ 371 Date: Nov. 4, 2025

Related U.S. Application Data
(60) Provisional application No. 63/523,931, filed on Jun. 29, 2023.

(51) Int. Cl. C09D 5/18; C08K 3/22; C08K 5/52; C08K 9/04; C09D 7/62; C09D 7/63; C09D 123/06

(52) U.S. Cl. CPC C09D 5/185; C09D 7/62; C09D 7/63; C09D 123/06; C08K 2003/2227; C08K 5/5205; C08K 9/04

(57) ABSTRACT

A polymeric composition includes 15 wt % to 95 wt % of a non-polar ethylene-based polymer based on the total weight of the polymeric composition; 0 wt % to 35 wt % of a polar ethylene-based polymer based on the total weight of the polymeric composition; and 5 wt % to 50 wt % of an intumescent flame-retardant mixture based on the total weight of the polymeric composition. The intumescent flame-retardant mixture includes piperazine pyrophosphate and from 15 wt % to 55 wt % of a phosphoric acid compound based on the total weight of the intumescent flame-retardant mixture.

### BACKGROUND

### Field of the Disclosure

The present disclosure relates to polymeric compositions, and more specifically to filled flame retardant polymeric compositions.

### INTRODUCTION

Jacket and/or insulation layers of wires and cables utilized in structures often must exhibit certain flame retardancy properties. Thermoplastic ethylene-based polymers (also known as polyethylenes) are often utilized as the base polymers in the compositions of such jackets or insulations when incorporating high levels of halogen-free flame retardant (“HFFR”) fillers in such materials. The HFFR fillers may be metal hydroxides or a variety of other materials and are typically polar. Typically the base thermoplastic ethylene-based polymer of the polymeric composition is polar (such as ethylene-vinyl acetate copolymer or ethylene-ethyl acrylate copolymer). The use of a polar ethylene-based polymer serves a dual benefit of assuring sufficient compatibility of the HFFR filler in the polymeric composition, and also providing a material to the polymeric composition that has a lower enthalpy of combustion than a non-polar ethylene-based polymer as described in the following publication: Cogen, J. M., Chaudhary, B. I., Ghosh-Dastidar, A., Sun, Y. and Wasserman, S. H., “Flame Retardant Aspects of Crosslinked Polyethylene (XLPE)”, In: Jince Thomas, Sabu Thomas and Zakiah Ahmad (eds.), Crosslinkable Polyethylene—Manufacture, Properties, Recycling and Applications, Chapter 9. Springer, 2021. pp. 211-245. For example, polyethylene homopolymer is reported to have enthalpy of combustion of 48 kJ/g, higher than that of polar ethylene-based polymers such as ethylene vinyl acetate copolymers (38 kJ/g or 42 kJ/g at vinyl acetate contents of 40 wt % and 25 wt %, respectively) or ethylene ethyl acrylate copolymers (43 kJ/g at ethyl acrylate content of 25 wt %). The lower the heat of combustion of a material, the lower the thermal energy produced. Thus, the peak heat release rate (“PHRR”) measured by cone calorimetry of an ethylene vinyl acetate copolymer (having 18 wt % vinyl acetate content) is about 19% lower than that of polyethylene homopolymer. Such a feature is advantageous as the polymeric compositions used to make flame-retardant wires and cables desirably need to exhibit a PHRR of 350 kW/m² or less.

In addition to the flame retardancy of the wires and cables, the densities of the polymeric compositions are also important. By decreasing the density of the jacket and/or insulation, the wire and cable products are manufactured, transported, and installed with greater efficiency and cost effectiveness. One approach for creating a lighter weight product is to use an intumescent type flame retardant as HFFR filler as described by the above-noted publication. An intumescent flame retardant is one that, when exposed to heat, is rapidly transformed through sublimation, and expands many times its original thickness to form a stable, carbonaceous char. Intumescent flame retardants are typically based on phosphorus and nitrogen compounds which decompose to form an insulating foam layer. These intumescent flame retardants are comprised of an acid source (such as ammonium polyphosphate), foaming agent (such as melamine) and a charring agent (such as pentaerythritol). In some cases, all three required functionalities (i.e., phosphorus, nitrogen and carbon sources) are delivered through the use of a single compound (such as piperazine pyrophosphate). Melamine polyphosphate is another example of an intumescent flame retardant. Intumescent flame retardants may be used in lower quantities than other HFFR counterparts such as metal hydroxides (hydrates) which allows for wires and cables produced therefrom to be lighter in weight due to the lower densities of the polymeric compositions. Typically, a density of 1.40 grams per cubic centimeter (“g/cc”) or less of the polymeric composition would especially be considered an improvement over the traditional metal hydroxide filled HFFR systems (while yielding a PHRR of 350 kW/m² or less), with a density as high as 1.7 g/cc being considered acceptable.

Although intumescent flame retardants offer an advantage in terms of light weighting, the use of intumescent flame retardants poses several issues. First, intumescent flame retardants are typically confined in practice to compositions based on polypropylene and not based on polyethylene. For example, United States Patent Application Publication number 2003/0088000A1 disclose the use of intumescent compounds, but all of the examples rely on systems comprising 72 weight percent of polypropylene or greater and no polyethylene. As such, it is unknown what composition of intumescent, level of intumescent loading, and ethylene-based polymer composition would provide effective flame retardancy and lightweighting benefits to polyethylene systems while yielding satisfactory mechanical properties.

In view of the foregoing, it would be surprising to discover a polymeric composition comprising a non-polar ethylene-based polymer and an intumescent flame retardant that achieves a PHRR of less than 350 kW/m² and preferably has a density of 1.70 g/cc or less (with the PHRR being less than that attained using a polar ethylene-based polymer as the polymer component in otherwise identical formulations).

### SUMMARY OF THE DISCLOSURE

The inventors of the present disclosure have discovered a polymeric composition comprising a non-polar ethylene-based polymer and an intumescent flame retardant that achieves a PHRR of less than 350 kW/m² and preferably has a density of 1.70 g/cc or less.

The present disclosure is a result of discovering that the use of non-polar ethylene-based polymers to make thermoplastic HFFR compositions with intumescent flame-retardant mixtures greatly improves the flame-retardant performance of the resulting polymeric compositions versus the use of polar ethylene-based polymers in otherwise identical formulations. Such a result is unexpected because the heats of combustion of non-polar ethylene-based polymers are greater than those of polar ethylene-based polymers. Furthermore, polymeric compositions comprising non-polar ethylene-based polymers and intumescent flame-retardant mixtures have been discovered that exhibit similar or better flame retardancy as incumbent HFFR systems made of polar ethylene-based polymers and metal hydroxide fillers, at much lower compound densities (despite intumescent flame retardants having been limited previously to systems not based on ethylene-based polymers).

The present disclosure is particularly useful for the formation of flame-retardant polymeric compositions.

According to a first feature of the present disclosure, a polymeric composition comprises 5 wt % to 95 wt % of a non-polar ethylene-based polymer based on the total weight of the polymeric composition; 0 wt % to 35 wt % of a polar ethylene-based polymer based on the total weight of the polymeric composition; and 5 wt % to 90 wt % of an intumescent flame-retardant mixture based on the total weight of the polymeric composition, wherein the intumescent flame-retardant mixture comprises piperazine pyrophosphate and from 15 wt % to 55 wt % of phosphoric acid compound based on the total weight of the intumescent flame-retardant mixture.

According to a second feature of the present disclosure, a density of the non-polar ethylene-based polymer is 0.930 g/cc or less and the non-polar ethylene-based polymer is linear or substantially linear.

According to a third feature of the present disclosure, the polymeric composition is free of a polar ethylene-based polymer.

According to a fourth feature of the present disclosure, the polar ethylene-based polymer is present in the composition in an amount of 0.1 wt % to 35 wt % based on the total weight of the polymeric composition.

According to a fifth feature of the present disclosure, the polymeric composition comprises 0.1 wt % to 50 wt % of a halogen free flame retardant based on the total weight of the polymeric composition.

According to a sixth feature of the present disclosure, the polymeric composition comprises from 5 wt % to 35 wt % of the intumescent flame-retardant mixture.

According to a seventh feature of the present disclosure, the polymeric composition comprises from 7 wt % to 31 wt % of the intumescent flame-retardant mixture.

According to an eighth feature of the present disclosure, the intumescent flame-retardant mixture comprises from 25 wt % to 45 wt % of phosphoric acid compound based on the total weight of the intumescent flame-retardant mixture.

According to a ninth feature of the present disclosure, the phosphoric acid compound is selected from the group consisting of melamine polyphosphate, ammonium polyphosphate, or combinations thereof.

According to a tenth feature of the present disclosure, the intumescent flame-retardant mixture comprises a flame-retardant synergist comprising a metal oxide.

According to an eleventh feature of the present disclosure, the polymeric composition exhibits a peak heat release rate of 350 kW/m² or less.

According to a twelfth feature of the present disclosure, the polymeric composition exhibits a tensile elongation of 75% or greater and the polymeric composition preferably exhibits a density of 1.7 g/cc or less.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

### Polymeric Composition

The present disclosure is directed to a polymeric composition. The polymeric composition may comprise a non-polar ethylene-based polymer, a polar ethylene-based polymer and an intumescent flame-retardant mixture. The polymeric composition may also comprise an HFFR that is separate and distinct from the intumescent flame-retardant mixture.

“Polymer” means a polymeric material prepared by polymerizing monomers, whether of the same or a different type. The generic term polymer thus embraces the terms homopolymer, interpolymer and copolymer.

The polymeric composition may have a density of 1.70 g/cc or less as measured according to ASTM D792. For example, the polymeric composition may exhibit a density of 1.70 g/cc or less, or 1.65 g/cc or less, 1.60 g/cc or less, or 1.55 g/cc or less, or 1.50 g/cc or less, or 1.45 g/cc or less, or 1.40 g/cc or less, or 1.35 g/cc or less, or 1.30 g/cc or less, or 1.25 g/cc or less, or 1.20 g/cc or less, or 1.15 g/cc or less, or 1.10 g/cc or less, or 1.05 g/cc or less, or 1.00 g/cc or less, or 0.95 g/cc or less as measured according to ASTM D792. The polymeric composition may have a density of 0.90 g/cc or greater as measured according to ASTM D792.

The polymeric composition may exhibit a tensile strain at break of 75% or greater as measured according to ASTM D638-10. For example, the polymeric composition may exhibit a tensile strain at break of 75% or greater, or 80% or greater, or 90% or greater, or 100% or greater, or 110% or greater, or 120% or greater, or 130% or greater, or 140% or greater, or 150% or greater, or 175% or greater, or 200% or greater, or 250% or greater, or 300% or greater, or 400% or greater, or 500% or greater, while at the same time, 600% or less, or 500% or less, or 400% or less, or 300% or less, or 250% or less, or 200% or less, or 150% or less, or 100% or less as measured according to ASTM D638-10.

The polymeric composition may exhibit a peak heat release rate of 350 kW/m² or less as measured according to the test method provided below. For example, the PHRR of the polymeric composition may be 350 kW/m² or less, or 325 kW/m² or less, or 300 kW/m² or less, or 275 kW/m² or less, or 250 kW/m² or less, or 225 kW/m² or less, or 200 kW/m² or less, or 175 kW/m² or less, or 150 kW/m² or less, or 125 kW/m² or less, or 100 kW/m² or less, or 75 kW/m² or less, or 50 kW/m² or less.

### Non-Polar Ethylene-Based Polymer

The polymeric composition comprises a non-polar ethylene-based polymer. As used herein, the term “non-polar” when used in connection with a polymer means that it comprises 0.1 wt % or less of a polar monomer or comonomer as measured using Nuclear Magnetic Resonance (“NMR”) or Fourier-Transform Infrared (“FTIR”) Spectroscopy or X-ray Fluorescence (XRF) techniques. As used herein, “ethylene-based” polymers are polymers in which greater than 50 wt % of the monomers are ethylene though other co-monomers may also be employed. Descriptions of “ethylene-based” polymers (both polar and non-polar) can be found in Patel, R., “Types and Basics of Polyethylene”, In: Mark A. Spalding and Ananda M. Chatterjee (eds.), Handbook of Industrial Polyethylene and Technology, Chapter 4. Scrivener, 2017. pp. 105-138. The non-polar ethylene-based polymer can include ethylene and one or more C₃-C₂₀ α-olefin comonomers such as propylene, 1-butene, 1 pentene, 4-methyl-1-pentene, 1-hexene, and 1-octene. The non-polar ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weights, molecular weight distributions, densities, etc.). If a blend of ethylene-based polymers is employed, the polymers can be blended by any in-reactor or post-reactor process. The term “multimodal” refers to polymers that are characterized by having at least two distinct peaks in a gel permeation chromatography (GPC) chromatogram depicting the molecular weight distribution of the composition. Accordingly, the generic term multimodal polymer includes bimodal polymers, which have two primary fractions: a first fraction, which may be a low molecular weight fraction and/or component, and a second fraction, which may be a high molecular weight fraction and/or component.

The non-polar ethylene-based polymer may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 98.5 wt % or greater, or 99 wt % or greater, or 99.5 wt % or greater, while at the same time, 100 wt % or less, or 99.5 wt % or less, or 99 wt % or less, or 98.5 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene as measured using NMR or FTIR Spectroscopy or XRF. Other units of the ethylene-based polymer may include C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene.

The non-polar ethylene-based polymer may have long-chain branching and/or short-chain branching and as such may be classified as branched, linear or substantially linear. As here used, “substantially linear” means that the bulk polymer is substituted, on average, with about 0.01 long-chain branches/1000 total carbons (including both backbone and branch carbons) to about 3 long-chain branches/1000 total carbons, preferably from about 0.01 long-chain branches/1000 total carbons to about 1 long-chain branch/1000 total carbons, more preferably from about 0.05 long-chain branches/1000 total carbons to about 1 long-chain branch/1000 total carbons, and especially from about 0.3 long chain branches/1000 total carbons to about 1 long chain branches/1000 total carbons. “Long-chain branches” or “long-chain branching” (LCB) means a chain length of at least one (1) carbon less than the number of carbons in the comonomer, as opposed to “short chain branches” or “short chain branching” (SCB) which means a chain length two (2) less than the number of carbons in the comonomer. For example, an ethylene/1-octene substantially linear polymer has backbones with long chain branches of at least seven (7) carbons in length, but it also has short chain branches of only six (6) carbons in length, whereas an ethylene/l-hexene substantially linear polymer has long chain branches of at least five (5) carbons in length but short chain branches of only four (4) carbons in length. LCB can be distinguished from SCB by using 13C nuclear magnetic resonance (NMR) spectroscopy and to a limited extent, e.g. for ethylene homopolymers, it can be quantified using the method of Randall (Rev. Macromol. Chem. Phys., C29 (2&3). p. 285-297). However, as a practical matter, current ¹³C NMR spectroscopy cannot determine the length of a long-chain branch in excess of about six (6) carbon atoms and as such, this analytical technique cannot distinguish between a seven (7) and a seventy (70) carbon branch. The LCB can be about as long as about the same length as the length of the polymer backbone. Examples of non-polar ethylene-based polymer are low density polyethylene (branched, with a high level of “tree-like” LCB, typically about 2 to 3 LCB/1000 carbon atoms), linear low density polyethylene (such as ATTANE™ and DOWLEX™ grades from The Dow Chemical Company), high density polyethylene and substantially linear ethylene-based polymers (such as AFFINITY™ Polyolefin Plastomers and ENGAGE Polyolefin Elastomers from The Dow Chemical Company).

The non-polar ethylene-based polymer may have a density of 0.850 g/cc to 0.970 g/cc g/cc or less as measured according to ASTM D792. For example, the non-polar ethylene-based polymer may have a density of 0.850 g/cc or greater, 0.860 g/cc or greater, or 0.870 g/cc or greater, or 0.880 g/cc or greater, or 0.890 g/cc or greater, or 0.900 g/cc or greater, or 0.910 g/cc or greater, or 0.915 g/cc or greater, or 0.920 g/cc or greater, or 0.921 g/cc or greater, or 0.922 g/cc or greater, or 0.925 g/cc or greater, or 0.928 g/cc or greater, while at the same time, 0.970 g/cc or less, or 0.960 g/cc or less, or 0.950 g/cc or less, or 0.940 g/cc or less, or 0.930 g/cc or less, or 0.925 g/cc or less, or 0.920 g/cc or less, or 0.915 g/cc or less, or 0.910 g/cc or less, or 0.900 g/cc or less, or 0.890 g/cc or less, or 0.880 g/cc or less, or 0.870 g/cc or less, or 0.865 g/cc or less, or 0.860 g/cc or less, or 0.855 g/cc or less as measured by ASTM D792.

The non-polar ethylene-based polymer has a melt index as measured according to ASTM D1238 under the conditions of 190° C./2.16 kilogram (kg) weight and is reported in grams eluted per 10 minutes (g/10 min). The melt index of the non-polar ethylene-based polymer may be 0.3 g/10 min or greater, or 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, or 5.0 g/10 min or greater, or 5.5 g/10 min or greater, or 6.0 g/10 min or greater, while at the same time, 30.0 g/10 min or less, or 25.0 g/10 min or less, or 20.0 g/10 min or less, or 15.0 g/10 min or less, or 10.0 g/10 min or less, or 6.0 g/10 min or less, or 5.5 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less, or 0.5 g/10 min or less.

The polymeric composition may comprise from 5 wt % to 95 wt % of the non-polar ethylene-based polymer. For example, the polymeric composition comprises 5 wt % or greater, 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 93 wt % or greater, while at the same time, 95 wt % or less, or 93 wt % or less, or 90 wt % or less, 85 wt % or less, or 80 wt % or less, 75 wt % or less, or 70 wt % or less, 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less of the non-polar ethylene-based polymer based on the total weight of the polymeric composition.

### Polar Ethylene-Based Polymer

The polymeric composition may comprise a polar ethylene-based polymer. As used herein, the term “polar” when used in connection with a polymer means that it comprises 0.1 wt % or more of a polar monomer or comonomer as measured using NMR or FTIR Spectroscopy or XRF techniques. Units other than ethylene of the polar ethylene-based polymer may be derived from one or more polymerizable monomers including, but not limited to, acids and unsaturated esters. The acids may be acrylic acid and methacrylic acid. The unsaturated esters may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2-ethylhexyl acrylate. Examples of vinyl carboxylates include, but are not limited to, vinyl acetate, vinyl propionate, and vinyl butanoate. The polar ethylene-based polymer typically has a high level of LCB, can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of polar ethylene-based polymers is employed, the polymers can be blended by any in-reactor or post-reactor process.

The polar ethylene-based polymer may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 98.5 wt % or greater, or 99 wt % or greater, while at the same time, 99.5 wt % or less, or 99 wt % or less, or 98.5 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene monomers as measured using NMR or FTIR Spectroscopy or XRF. The polar ethylene-based polymer may have a polar comonomer content of 50 wt % or less, or 45 wt % or less, or 40 wt % or less, or 35 wt % or less, or 30 wt % or less, or 25 wt % or less, or 20 wt % or less, 15 wt %, or 10 wt %, or 5 wt % or less, or 3 wt % or less, or 1 wt % or less, or 0 wt % based on the total weight of the ethylene-based polymer as measured using NMR or FTIR Spectroscopy or XRF.

The density of the polar ethylene-based polymer may be from 0.925 g/cc to 0.985 g/cc as measured according to ASTM D792. For example, the density of the polar ethylene-based polymer may be 0.925 g/cc or greater, or 0.930 g/cc or greater, or 0.935 g/cc or greater, or 0.940 g/cc or greater, 0.945 g/cc or greater, or 0.950 g/cc or greater, or 0.955 g/cc or greater, or 0.960 g/cc or greater, or 0.965 g/cc or greater, or 0.970 g/cc or greater, or 0.975 g/cc or greater, or 0.980 g/cc or greater, while at the same time, 0.985 g/cc or less, or 0.980 g/cc or less, or 0.975 g/cc or less, or 0.970 g/cc or less, or 0.965 g/cc or less, or 0.960 g/cc or less, or 0.955 g/cc or less, or 0.950 g/cc or less, or 0.945 g/cc or less, or 0.940 g/cc or less, or 0.935 g/cc or less, or 0.930 g/cc or less as measured according to ASTM D792.

The melt index of the polar ethylene-based polymer may be 0.3 g/10 min or greater, or 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, or 5.0 g/10 min or greater, or 5.5 g/10 min or greater, or 6.0 g/10 min or greater, while at the same time, 30.0 g/10 min or less, or 25.0 g/10 min or less, or 20.0 g/10 min or less, or 15.0 g/10 min or less, or 10.0 g/10 min or less, or 6.0 g/10 min or less, or 5.5 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less, or 0.5 g/10 min or less as measured according to ASTM D1238 under the conditions of 190° C./2.16 kilogram (kg) weight.

The polymeric composition may be free of polar ethylene-based polymer. The polymeric composition may comprise from 0 wt % to 35 wt % of a polar ethylene-based polymer based on the total weight of the polymeric composition. For example, the polymeric composition may comprise 0 wt % or greater, or 0.1 wt % or greater, or 0.3 wt % or greater, or 0.5 wt % or greater, or 1 wt % or greater, or 3 wt % or greater, or 5 wt % or greater, or 10 wt % or greater, or 15 wt % or greater, or 20 wt % or greater, or 25 wt % or greater, or 30 wt % or greater, while at the same time, 35 wt % or less, or 30 wt % or less, or 25 wt % or less, or 20 wt % or less, or 15 wt % or less, or 10 wt % or less, or 5 wt % or less, or 3 wt % or less, or 1 wt % or less, or 0.5 wt % or less, or 0.3 wt % or less, or 0.1 wt % or less of the polar ethylene-based polymer based on the total weight of the polymeric composition.

### Halogen-Free Flame Retardant

The polymeric composition may comprise the halogen-free flame retardant. The halogen-free flame retardant of the polymeric composition can inhibit, suppress, or delay the production of flames. As used herein, “halogen-free” and like terms indicate that the flame-retardant filler is without or substantially without halogen content, i.e., contains less than 10,000 mg of halogen per kg of flame-retardant filler as measured by ion chromatography (IC) or a similar analytical method. Halogen content of less than this amount is considered inconsequential to the efficacy of the flame-retardant filler as, for example, in a coated conductor. Examples of the halogen-free flame retardants suitable for use in the polymeric composition include, but are not limited to, intumescent flame retardants and other halogen-free flame retardants including metal hydrates (such as aluminum hydroxide, magnesium hydroxide), metal carbonates, red phosphorous, silica, alumina, Brucite (mineral form of magnesium hydroxide), metal oxides (such as zinc oxide, calcium oxide, magnesium oxide, titanium oxide), carbon nanotubes, talc, clay, organo-modified clay, calcium carbonate, zinc borate, antimony trioxide, wollastonite, mica, ammonium octamolybdate, frits, hollow glass microspheres, intumescent materials or compounds, expanded graphite, and combinations thereof. In an embodiment, the other halogen-free flame retardant is selected from fillers that have hydroxide moieties (such as metal hydrates) and/or hydroxyl groups (such as silica). In an embodiment, the metal hydrate of the other halogen-free flame retardant can be selected from the group consisting of aluminum hydroxide, magnesium hydroxide, calcium hydroxide, zinc hydroxide, iron hydroxide, copper hydroxide, and combinations thereof. In an embodiment, the other halogen-free flame retardant is selected from the group consisting of a metal hydrate, metal oxide, silica, and combinations thereof. The other halogen-free flame retardant can optionally be surface treated (coated) with a silane, or a saturated or unsaturated carboxylic acid having 8 to 24 carbon atoms, or 12 to 18 carbon atoms, or a metal salt of the acid, or other materials. Exemplary surface treatments are described in U.S. Pat. Nos. 4,255,303, 5,034,442, 7,514,489, US 2008/0251273, and WO 2013/116283. Alternatively, the silane or acid or salt can be merely added to the composition in like amounts rather than using the surface treatment procedure. Other surface treatments known in the art may also be used including titanates, phosphates and zirconates.

Commercially available examples of other halogen-free flame retardants suitable for use in the polymeric composition include, but are not limited to, APYRAL™ 40CD aluminum hydroxide available from Nabaltec AG, MAGNIFIN™ H5 magnesium hydroxide available from Magnifin Magnesiaprodukte GmbH & Co KG, Microcarb 95T ultramicronized and treated calcium carbonate available from Reverte, and combinations thereof.

The polymeric composition may comprise other halogen-free flame retardants in a concentration of 0 wt %, or 0.1 wt % or greater, or 0.5 wt % or greater, or 1 wt % or greater, or 3 wt % or greater, or 5 wt % or greater, or 7 wt % or greater, or 10 wt % or greater, or 12 wt % or greater, or 14 wt % or greater, or 16 wt % or greater, or 18% or greater, or 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, 40 wt % or greater, or 42 wt % or greater, or 44 wt % or greater, or 46 wt % or greater, or 48% or greater, while at the same time, 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less, or 10 wt % or less, or 7 wt % or less, or 5 wt % or less, or 3 wt % or less, or 1 wt % or less, or 0.5 wt % or less based on the total weight of the polymeric composition.

### Intumescent Flame-Retardant Mixture

The polymeric composition comprises the intumescent flame-retardant mixture as HFFR filler. The intumescent flame-retardant mixture may comprise piperazine pyrophosphate and a phosphoric acid compound. The intumescent flame-retardant mixture may comprise from 45 wt % to 85 wt % piperazine pyrophosphate based on the total weight of the intumescent flame-retardant mixture. For example, the intumescent flame-retardant mixture may comprise 45 wt % or greater, or 50 wt % or greater, or 55 wt % or greater, or 60 wt % or greater, or 65 wt % or greater, or 70 wt % or greater, or 75 wt % or greater, or 80 wt % or greater, while at the same time, 85 wt % or less, or 80 wt % or less, or 75 wt % or less, or 70 wt % or less, or 65 wt % or less, or 60 wt % or less, or 55 wt % or less, or 50 wt % or less, or 45 wt % or less of the piperazine pyrophosphate based on the total weight of the intumescent flame-retardant mixture. The intumescent flame-retardant mixture may comprise from 15 wt % to 55 wt % of the phosphoric acid compound based on the total weight of the intumescent flame-retardant mixture. For example, the intumescent flame-retardant mixture comprises 15 wt % or greater, or 20 wt % or greater, or 25 wt % or greater, or 30 wt % or greater, or 35 wt % or greater, or 40 wt % or greater, or 45 wt % or greater, or 50 wt % or greater, while at the same time, 55 wt % or less, or 50 wt % or less, or 45 wt % or less, or 40 wt % or less, or 35 wt % or less, or 30 wt % or less, or 25 wt % or less, or 20 wt % or less of phosphoric acid compound based on the total weight of the intumescent flame-retardant mixture. The phosphoric acid compound may be made of one or more materials. The phosphoric acid compound is a salt formed by the reaction of phosphoric acid or polyphosphoric acid with amines. The phosphoric acid compound is selected from one of melamine polyphosphate (a reaction product of melamine and polyphosphoric acid), ammonium polyphosphate (a reaction product of ammonia and polyphosphoric acid), or a combination thereof.

The intumescent flame-retardant mixture may comprise from 0 wt % to 20 wt % of a flame-retardant synergist based on the total weight of the intumescent flame-retardant mixture. For example, the intumescent flame-retardant mixture may comprise 0 wt % or greater, or 0.5 wt % or greater, or 1.0 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, or 10 wt % or greater, while at the same time, 20 wt % or less, or 18 wt % or less, or 16 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less, or 5 wt % or less, or 4 wt % or less, or 3 wt % or less, or 2 wt % or less, or 1 wt % or less, or 0.5 wt % or less, or 0 wt % of the flame retardant synergist based on the total weight of the intumescent flame-retardant mixture. The flame-retardant synergist in the intumescent flame-retardant mixture may be a silicone component (such as, but not limited to, silicone gum). The flame-retardant synergist in the intumescent flame-retardant mixture may be a metal oxide. In an embodiment, the flame-retardant synergist in the intumescent flame-retardant mixture is zinc oxide.

The polymeric composition comprises from 5 wt % to 90 wt % of the intumescent flame-retardant mixture as HFFR filler based on the total weight of the polymeric composition. For example, the polymeric composition comprises 5 wt % or greater, or 7 wt % or greater, or 10 wt % or greater, or 15 wt % or greater, or 20 wt % or greater, or 25 wt % or greater, or 30 wt % or greater, or 31 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, while at the same time, 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 31 wt % or less, or 30 wt % or less, or 25 wt % or less, or 20 wt % or less, or 15 wt % or less, or 10 wt % or less, or 7 wt % or less of the intumescent flame-retardant mixture based on the total weight of the polymeric composition.

### Additives

The polymeric composition may include one or more additives. Nonlimiting examples of suitable additives include antioxidants, colorants, corrosion inhibitors, lubricants, ultraviolet (UV) absorbers or stabilizers, anti-blocking agents, flame-retardants, coupling agents, compatibilizers, plasticizers, fillers, processing aids, propylene polymers (homopolymers and copolymers including polypropylene homopolymer, random copolymer polypropylene and impact copolymer polypropylene), and combinations thereof. Compatibilizers include, but are not limited to, anhydride modified ethylene-based polymers (such as anhydride modified ethylene plastomers or elastomers).

The polymeric composition may include an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3 (3,5-di-tert-butyl-4-hydroxyphenyl)-propionate; n-octadecyl-3 (3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa [3-(3,5-di-tert-butyl-4-hydroxy-phenyl)-propionate]. The polymeric composition may include pentaerythritol tetrakis(3-(3,5-di-tert-butyl-4-hydroxyphenyl) propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis(benzylidiene hydrazide). The polymeric composition may contain from 0 wt %, or 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the polymeric composition.

The polymeric composition may include an ultraviolet (UV) absorber or stabilizer. A nonlimiting example of a suitable UV stabilizer is a hindered amine light stabilizer (HALS). A nonlimiting example of a suitable HALS is 1,3,5-Triazine-2,4,6-triamine, N,N-1,2-ethanediylbisN-3-4,6-bisbutyl(1,2,2,6,6-pentamethyl-4-piperidinyl)amino-1,3,5-triazin-2-ylaminopropyl-N,N-dibutyl-N,N-bis(1,2,2,6,6-pentamethyl-4-piperidinyl)-1,5,8,12-tetrakis [4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the composition.

The polymeric composition may include a processing aid. Nonlimiting examples of suitable processing aids include oils, organic acids (such as stearic acid), and metal salts of organic acids (such as zinc stearate). In an embodiment, the composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt %, or 20.0 wt % processing aid, based on total weight of the composition.

The polymeric composition may contain from 0 wt % or greater, or 0.001 wt % or greater, or 0.002 wt % or greater, or 0.005 wt % or greater, or 0.006 wt % or greater, or 0.008 wt % or greater, or 0.009 wt % or greater, or 0.01 wt % or greater, or 0.2 wt % or greater, or 0.3 wt % or greater, or 0.4 wt % or greater, or 0.5 wt % or greater, or 1.0 wt % or greater, or 2.0 wt % or greater, or 3.0 wt % or greater, or 4.0 wt % or greater, or 5.0 wt % or greater, or 10.0 wt % or greater, or 15.0 wt % or greater, or 20.0 wt % or greater, or 30 wt % or greater, or 40 wt % or greater, or 50 wt % or greater additive, based on the total weight of the polymeric composition.

### Coated Conductor

The present disclosure also provides a coated conductor. The coated conductor includes a conductor and a coating on the conductor, the coating including the polymeric composition. The polymeric composition is at least partially disposed around the conductor to produce the coated conductor. The conductor may comprise a conductive metal and/or an optical waveguide.

The polymeric composition is disposed on and/or around the conductor to form a coating. The coating may be one or more inner layers such as an insulating layer. The coating may wholly or partially cover or otherwise surround or encase the conductor. The coating may be the sole component surrounding the conductor as an insulation or jacket. Alternatively, the coating may be one layer of a multilayer jacket or sheath encasing the conductor. The coating may directly contact the conductor. The coating may directly contact an insulation layer surrounding the conductor.

### EXAMPLES

### Test Methods

PHRR: PHRR data were collected using cone calorimetry. Cone calorimetry was conducted on a Fire Testing Technology cone calorimeter at heat flux of 50 kW/m² (or 35 kW/m² in the case of some comparative examples as indicated ahead with *) on horizontally set-up square specimens of 100 mm×100 mm×3 mm dimensions with a grid using the standardized cone calorimeter procedure (ASTM E-1354-11). Duplicate measurements per sample were made and the data of each replicate was averaged to give a representative profile of heat release rate curve (from which the PHRR and other useful data per formulation were determined). A more in-depth description of this test is given in the following publication: Cogen, J. M., Chaudhary, B. I., Ghosh-Dastidar, A., Sun, Y. and Wasserman, S. H., “Flame Retardant Aspects of Crosslinked Polyethylene (XLPE)”, In: Jince Thomas, Sabu Thomas and Zakiah Ahmad (eds.), Crosslinkable Polyethylene—Manufacture, Properties, Recycling and Applications, Chapter 9. Springer, 2021. pp. 211-245.

Tensile strength and tensile elongation were measured according to ASTM D638-14 at a displacement rate of 20 inches per minute using Type IV dog bone-shaped specimens obtained from the compression molded samples.

Density was measured according to ASTM D792, Method B or calculated as follows: For a given formulation, the “mL per 100 grams” of each ingredient or component is obtained by dividing “wt %” of that ingredient by its density in g/cm³. The individual values of “mL per 100 grams” of each ingredient are added to yield a total value of “mL per 100 grams” for that particular formulation. Next, the number “100” (representing the total wt % of all ingredients in that formulation) is divided by the total value of “mL per 100 grams”, to yield the “calculated density” of that specific formulation in g/cm³. It is expected that density measured according to ASTM D792 would provide the same or similar result.

Melt index (MI) values were measured in accordance with ASTM D1238 at 190° C. or 150° C. and using load of 2.16 kg or 21.6 kg.

Limiting oxygen index (LOI) was measured in accordance with ASTM D2863 and reflects the minimum concentration of oxygen, expressed as a percentage, that will support combustion of a polymer specimen. It is measured by passing a mixture of oxygen and nitrogen over a burning specimen, and adjusting the oxygen level until a critical level is reached.

### Materials

The materials used in the inventive examples (“IE”) and comparative examples (“CE”) are provided below.

POLAR1 is a polar ethylene vinyl acetate copolymer (ethylene-based polymer) having a density of 0.95 g/cc, a melt index (190° C.; 2.16 kg) of 3.0 g/10 min, and a 28 wt % vinyl acetate content. POLAR1 is commercially available as ELVAX™ 3182 ethylene vinyl acetate copolymer from The Dow Chemical Company, Midland, MI, United States.

POLAR2 is a polar ethylene vinyl acetate copolymer (ethylene-based polymer) having a density of 0.967 g/cc, a melt index (190° C.; 2.16 kg) of 3.0 g/10 min, and a 40 wt % vinyl acetate content. POLAR2 is commercially available as ELVAX™ 40L-03 ethylene vinyl acetate copolymer from The Dow Chemical Company, Midland, MI, United States.

POLAR3 is a polar ethylene ethyl acrylate copolymer (ethylene-based polymer) having a density of 0.930 g/cc, a melt index (190° C.; 2.16 kg) of 1.3 g/10 min, and a 15 wt % ethyl acrylate content. POLAR3 is commercially available as AMPLIFY™ EA 100 Functional Polymer from The Dow Chemical Company, Midland, MI, United States.

NPEP1 is a non-polar linear low-density polyethylene (ethylene-based polymer) having a density of 0.920 g/cc and a melt index (190° C.; 2.16 kg) of 1.0 g/10 min and is commercially available as DOWLEX™ 2045 G from The Dow Chemical Company, Midland, MI, United States.

NPEP2 is a non-polar linear low-density polyethylene (ethylene-based polymer) having a density of 0.921 g/cc and a melt index (190° C.; 2.16 kg) of 6.0 g/10 min and is commercially available as DOWLEX™ 2035 G from The Dow Chemical Company, Midland, MI, United States.

NPEP3 is a non-polar linear low-density polyethylene (ethylene-based polymer) having a density of 0.920 g/cc and a melt index (190° C.; 2.16 kg) of 3.5 g/10 min and is commercially available as DOW™ 1648 from The Dow Chemical Company, Midland, MI, United States.

NPEP4 is a non-polar polyolefin elastomer (ethylene-based polymer) having a density of 0.870 g/cc and a melt index (190° C.; 2.16 kg) of 5 g/10 min and is commercially available as ENGAGE™ 8200 from The Dow Chemical Company, Midland, MI, United States.

COMP is a anhydride modified ethylene plastomer (ethylene-based polymer) compatibilizer and is commercially available as FUSABOND™ N208 from The Dow Chemical Company, Midland, MI.

COMP2 is an anhydride modified ethylene elastomer (ethylene-based polymer) compatibilizer and is commercially available as FUSABOND™ N216 from The Dow Chemical Company, Midland, MI.

HFFR1 is fatty acid coated magnesium hydroxide and is commercially available as KISUMA™ 5B-1G from Kisuma Chemicals B.V., Veendam, NL.

HFFR2 is vinyl-silane coated magnesium hydroxide and is commercially available as MAGNIFIN™ H5-A from Magnifin Magnesiaprodukte GmbH & Co KG, Austria.

HFFR3 is zinc stearate surface treated talc commercially available as MISTRON™ ZSC from Nagase Specialty Materials, Itasca, IL, United States.

HFFR4 is uncoated aluminum hydroxide (ATH) and is commercially available as APYRAL™ 40CD from Nabeltec AG, Schwandorf, Germany.

HFFR5 is magnesium hydroxide (MDH) that is stearic acid treated at maximum 1 wt %, and is commercially available as ECOPIREN 3.5LC from Europiren B. V., Rotterdam, NL.

IFRM is a HFFR that is an intumescent flame-retardant mixture of 65 wt % piperazine pyrophosphate and 35 wt % melamine polyphosphate with a nitrogen content≥19%, phosphorus content≥17.0% and water content≤0.2%. The piperazine pyrophosphate is of 1.74 g/cc density and melamine polyphosphate has a density of 1.85 g/cc, meaning that the density of IFRM is 1.78 g/cc. IFRM is commercially available as JNP™-2-3 from CENTURY MULTECH, INC, Flushing, NY, United States.

SI is siloxane powder commercially available as DOWSIL™ Si Powder Resin Modifier 4-7081 which is commercially available from The Dow Chemical Company, Midland, MI.

GPS is a combination of ultra high molecular weight silicone gum and fumed silica in pellet form that is commercially available as GENIOPLAST Pellet S from Wacker Chemie AG, Munich, Germany.

AO1 is pentaerythritol tetrakis [3-[3,5-di-tert-butyl-4-hydroxyphenyl] propionate and is commercially available as IRGANOX™ 1010 FF from BASF, Ludwigshafen, Germany.

AO2 is distearyl thio dipropionate (C₄₂H₈₂O₄S) and is commercially available as MORSTILLE™ 18C DSTDP from Struktol, OH, United States.

MDAO is 1,2-Bis(3,5-di-tert-butyl-4-hydroxyhydrocinnamoyl) hydrazine which serves as a metal deactivator and antioxidant. MDAO is commercially available as SONGNOX™ 1024 FF from Songwon International AG, Frauenfeld, Germany.

MD is FUTURECHEM™ OABH (oxalyl bis(benzylidene) hydrazide) which serves as a metal deactivator. MD is commercially available from FutureFuel Chemical Company, Missouri, USA.

LSAO is C₁₃₂H₂₅₀N₃₂ and functions as a hindered amine light stabilizer and antioxidant. LSAO is commercially available as CHIMASSORB™ 119 FL from SABO Spa, Italy.

CAT is dibutyltin dilaurate and functions as a silanol condensation catalyst for moisture cure when used in combination with alkoxysilane functionalized polymers. CAT has a CAS number of 77-58-7 and is commercially available as FASCAT™ 4202 from PMC Organometallix, Mount Laurel, NJ, US.

OTS is Octyltriethoxysilane which functions as a moisture scavenger and is commercially available as PROSIL™ 9202 from SiVance LLC, of Milliken & Co, USA. It is useful in combination with alkoxysilane functionalized polymers.

### Sample Preparation

The sample formulations of IE1 and CE1 to CE10 in Table 1 were prepared using a Brabender mixer equipped with Cam rotors and resulting bowl volume of 420 mL, while IE2 and IE3 were formed using the same mixer equipped with Banbury rotors with resulting bowl volume of 375 ml. In all cases, the mixing was done at a rotor speed of 50 revolutions per minute and a set temperature of 135° C. while filling 70% of the bowl volume. The HFFR fillers (including IFRM) were dried for 16 hours at 60° C. in a vacuum oven before use. The order of addition was ethylene-based polymer(s), compatibilizer, antioxidant(s), HFFR fillers (including IFRM) and other additives. Mixing was done for 5 minutes after all the ingredients had been added. The melt-blended composition was removed from the mixing bowl and compression molded into plaques of desired thicknesses for property testing.

The sample formulations of IE4 and IE5 in Table 2 were prepared using a Brabender mixer equipped with Cam rotors and resulting bowl volume of 420 mL at a rotor speed of 50 rpm and set temperature of 125° C. while filling 70% of the bowl volume. The HFFR filler (IFRM) was dried for 16 hr at 60° C. in a vacuum oven before use. The ethylene-based polymer(s) was/were fluxed in the mixing bowl for 5 minutes before adding the other ingredients. The order of addition was ethylene-based polymer(s), antioxidant(s), IFRM and other additives. When adding the various solid ingredients, the mixing blade speed was reduced to about 20 rpm. After all the ingredients had been added, mixing was done for 5 minutes.

The procedure used to prepare the sample formulation of IE6 was the same as that for IE4 and IE5, except for: (a) using roller blades at rotor speed of 40 rpm with resulting bowl volume of 350 mL; (b) using a set temperature of 150° C.; (c) mixing for 10 minutes after all the ingredients had been added; and (d) not drying the IFRM before use.

The procedure used to prepare the sample formulation of IE7 was the same as that for IE6, except for the order of addition being as follows: ethylene-based polymer(s), COMP2, GPS, antioxidant(s), MD, HFFR4, HFFR5, IFRM, OTS and CAT.

Each of the melt-blended compositions of IE4 to IE7 was removed from the mixing bowl and compression molded fat 120° C. with 500 psi (3.4 MPa) pressure for 5 minutes into a plaque/sheet of 75 mil (1.905 mm) thickness that was subsequently was cut into strips using guillotine which were fed to a pelletizer, to make “chips”. These “chips” were next introduced to a Brabender ¾″ extruder equipped with a Maddock mixing screw of 25:1 length-to-diameter (L/D) ratio operated at 40 rpm with set temperature profile of 140° C./145° C./150° C./155° C. across zone 1, zone 2, zone 3 and head/die (using a 40/60/100 mesh screen pack). The composition was fabricated into a strand that in turn was converted to pellets using a pelletizer. The pellets were dried for 16 to 24 hours at 70° C. in a vacuum oven and thereafter packaged in a vacuum-sealed foil bag until the time of use. Where appropriate, for testing of properties, plaques of 75 mil (1.905 mm) or 125 mil (3.175 mm) thickness were prepared by compression molding at 500 psi (3.4 MPa) at 150° C. for 3 minutes, followed by 2500 psi (17.2 MPa) at 150° C. for 3 minutes, followed by cooling to 30° C. at 2500 psi (17.2 MPa) pressure.

### Results

Table 1 provides the compositions of IE1-IE3 and CE1-CE10 as well as the related performance properties.

TABLE 1

| Ex | IE1 | IE2 | IE3 | CE1 | CE2 | CE3 | CE4 | CE5 | CE6 | CE7 | CE8 | CE9 | CE10 |
|---|---|---|---|---|---|---|---|---|---|---|---|---|---|
| POLAR1 | | 12.0 | 12.0 | 19.4 | 16.9 | 14.4 | 39.4 | 35.6 | 31.9 | 40.0 | 37.0 | 38.0 | 38.0 |
| POLAR2 | | 11.8 | 11.8 | 19.4 | 16.9 | 14.4 | 39.4 | 35.7 | 31.9 | | | | |
| NPEP1 | 63.8 | | | | | | | | | 42.8 | 39.8 | 39.8 | 39.8 |
| NPEP2 | | 50.0 | 22.0 | | | | | | | | | | |
| COMP | 6.0 | 5.0 | 5.0 | 6.0 | 6.0 | 6.0 | 6.0 | 6.0 | 6.0 | 2.0 | 3.0 | 2.0 | 2.0 |
| HFFR1 | | | | 55.0 | 60.0 | 65.0 | | | | | | | |
| HFFR2 | | | 37.0 | | | | | | | | | | |
| HFFR3 | | | 3.0 | | | | | | | | | | 5.0 |
| IFRM | 30.0 | 20.0 | 8.0 | | | | 15.0 | 22.5 | 30.0 | 15.0 | 20.0 | 15.0 | 15.0 |
| SI | | | | | | | | | | | | 5.0 | |
| AO1 | 0.2 | 0.2 | 0.2 | 0.2 | 0.2 | 0.2 | 0.2 | 0.2 | 0.2 | 0.2 | 0.2 | 0.2 | 0.2 |
| AO2 | | 0.1 | 0.1 | | | | | | | | | | |
| MDAO | | 0.1 | 0.1 | | | | | | | | | | |
| LSAO | | 0.8 | 0.8 | | | | | | | | | | |
| TOTAL | 100 | 100 | 100 | 100 | 100 | 100 | 100 | 100 | 100 | 100 | 100 | 100 | 100 |
| Polar | 0.0 | 23.8 | 23.8 | 38.8 | 33.8 | 28.8 | 78.8 | 71.3 | 63.8 | 40.0 | 37.0 | 38.0 | 38.0 |
| Ethylene- | | | | | | | | | | | | | |
| Based | | | | | | | | | | | | | |
| Polymer | | | | | | | | | | | | | |
| (wt %) | | | | | | | | | | | | | |
| Calculated | 1.008 | 0.988 | 1.281 | 1.422 | 1.488 | 1.561 | 0.994 | 1.015 | 1.037 | 0.976 | 0.990 | 0.989 | 1.011 |
| density (g/cc) | | | | | | | | | | | | | |
| Tensile | 14.5 | NA | NA | 9.9 | 10.3 | 11.3 | 9.9 | 8.7 | 6.3 | 17.7 | 16.7 | 15.6 | 15.6 |
| Strength | | | | | | | | | | | | | |
| (mPa) | | | | | | | | | | | | | |
| Tensile | 139 | NA | NA | 271 | 197 | 134 | 787 | 763 | 716 | 767 | 747 | 739 | 747 |
| Elongation, | | | | | | | | | | | | | |
| % | | | | | | | | | | | | | |
| PHRR | 189 | 283 | 296 | 440 | 302 | 248 | 424 | 518 | 382 | 425* | 366* | 374* | 387* |
| (kW/m²) | | | | | | | | | | | | | |

NA: Not Available.
*Heat flux: 35 kW/m²

Referring now to Table 1, it can be seen that polymeric compositions of IE1 to IE3 comprising the non-polar ethylene-based polymer and the intumescent flame-retardant mixture yielded peak heat release rates in cone calorimetry of 350 kW/m² or less, calculated densities of 1.40 g/cc or less and tensile elongation values of 75% or greater. Referring now to CE1 to CE3, the inclusion of traditional loading levels of magnesium hydroxide (55 wt % to 65 wt %) resulted in unacceptably high densities while also not achieving the desired PHRR in the case of CE1. It can be seen in CE4-CE10 that the inclusion of greater than 35 wt % of polar polymer(s) in IFRM-containing formulations surprisingly resulted in the PHRR exceeding 350 kW/m². Also surprisingly, CE4-CE6 demonstrated failing PHRR value despite the ethylene-based polymer component being made entirely of lower enthalpy of combustion polar polymers. Of most relevant note, the IE1 resulted in PHRR that was half of that obtained with CE6, which is the most direct comparison showing the substantial advantage of using non-polar ethylene-based polymer instead of a polar ethylene-based polymer with intumescent flame-retardant mixtures.

Table 2 provides the compositions of IE4-IE7 as well as the related performance properties.

TABLE 2

| Ex | IE4 | IE5 | IE6 | IE7 |
|---|---|---|---|---|
| POLAR3 | 0.39 | 0.39 | | |
| NPEP3 | 26.43 | 8.25 | | |
| NPEP4 | | | 28.79 | 26.26 |
| COMP2 | | | | 4.00 |
| HFFR4 | | | | 26.30 |
| HFFR5 | | | | 26.30 |
| IFRM | 72.72 | 72.72 | 70.00 | 11.00 |
| GPS | | 18.18 | | 4.30 |
| AO1 | 0.30 | 0.30 | 0.38 | 0.38 |
| AO2 | | | 0.38 | 0.38 |
| MDAO | 0.15 | 0.15 | | |
| MD | | | 0.45 | 0.45 |
| LSAO | 0.01 | 0.01 | | |
| CAT | | | | 0.13 |
| OTS | | | | 0.50 |
| TOTAL | 100 | 100 | 100 | 100 |
| Polar Ethylene-Based Polymer | 0.39 | 0.39 | 0.00 | 0.00 |
| (wt %) | | | | |
| Calculated density (g/cc) | 1.420 | 1.508 | 1.360 | 1.465 |
| Measured density (g/cc) | NA | NA | 1.365 | 1.472 |
| Melt Index (150° C.; 21.6 | NA | NA | 1.9 | 5.1 |
| kg), dg/min | | | | |
| Tensile Strength (mPa) | NA | NA | 3.3 | 5.1 |
| Tensile Elongation, % | NA | NA | 713 | 249 |
| PHRR (kW/m²) | NA | NA | 54 | 149 |
| LOI (%) | NA | NA | 65 | 35 |

NA: Not Available.

Referring to Table 2, IE4 to IE7 desirably exhibited densities of 1.7 g/cc or less as well as good/outstanding values of LOI (higher is better), peak heat release rate (lower is better), melt index (higher is better) and tensile elongation (greater is better). Given the ease with which IE6 and IE7 could be made and extruded, reflected in their melt index values, it is very likely that the amount of IFRM in the inventive formulations could be increased significantly, possibly to as much as 90 wt %. Note that IE7, by virtue of containing dibutyltin dilaurate, would be suitable for moisture cure applications in combination with alkoxysilane functionalized polymers, to yield crosslinked compositions.

1. A polymeric composition, comprising:
5 wt % to 95 wt % of a non-polar ethylene-based polymer based on the total weight of the polymeric composition;
0 wt % to 35 wt % of a polar ethylene-based polymer based on the total weight of the polymeric composition; and
5 wt % to 90 wt % of an intumescent flame-retardant mixture based on the total weight of the polymeric composition, wherein the intumescent flame-retardant mixture comprises piperazine pyrophosphate and from 15 wt % to 55 wt % of a phosphoric acid compound based on the total weight of the intumescent flame-retardant mixture.

2. The polymeric composition of claim 1, wherein a density of the non-polar ethylene-based polymer is 0.930 g/cc or less and the non-polar ethylene-based polymer is linear or substantially linear.

3. The polymeric composition of claim 1, wherein the polymeric composition is free of a polar ethylene-based polymer.

4. The polymeric composition of claim 1, wherein the polar ethylene-based polymer is present in the composition in an amount of 0.1 wt % to 35 wt % based on the total weight of the polymeric composition.

5. The polymeric composition of claim 1, further comprising:
0.1 wt % to 50 wt % of a halogen free flame retardant based on the total weight of the polymeric composition.

6. The polymeric composition of claim 1, wherein the polymeric composition comprises from 5 wt % to 35 wt % of the intumescent flame-retardant mixture.

7. The polymeric composition of claim 6, wherein the polymeric composition comprises from 7 wt % to 31 wt % of the intumescent flame-retardant mixture.

8. The polymeric composition of claim 1, wherein the intumescent flame-retardant mixture comprises from 25 wt % to 45 wt % of phosphoric acid compound based on the total weight of the intumescent flame-retardant mixture.

9. The polymeric composition of claim 8, wherein the phosphoric acid compound is selected from the group consisting of melamine polyphosphate, ammonium polyphosphate, or combinations thereof.

10. The polymeric composition of claim 1, wherein the intumescent flame-retardant mixture comprises a flame-retardant synergist comprising a metal oxide.

11. The polymeric composition of claim 1, wherein the polymeric composition exhibits a peak heat release rate of 350 kW/m² or less.

12. The polymeric composition of claim 1, wherein the polymeric composition exhibits a tensile elongation of 75% or greater and the polymeric composition exhibits a density of 1.7 g/cc or less.
